(19) United States
(12) Patent Application Publication
(10) Pub. No.: US 2022/0361295 A1
(43) Pub. Date: Nov. 10, 2022

(54) A HEATING DEVICE

(71) Applicant: VALEO AUTOMOTIVE AIR CONDITIONING HUBEI CO. LTD., Jingzhou (CN)

(72) Inventors: Laurent Tellier, Jingzhou (CN); Ziran Tong, Jingzhou (CN); Qiang Geng, Jingzhou (CN); Ran Xiao, Jingzhou (CN); Fei Liu, Jingzhou (CN); Qiaozheng Wu, Jingzhou (CN); Xiaohui Liu, Jingzhou (CN)

(73) Assignee: VALEO AUTOMOTIVE AIR CONDITIONING HUBEI CO. LTD., Jingzhou (CN)

(21) Appl. No.: 17/765,135

(22) PCT Filed: Sep. 29, 2020
(86) PCT No.: PCT/CN2020/118625

§ 371 Date: Mar. 30, 2022

(30) Foreign Application Priority Data
Sep. 30, 2019 (CN) 201910941085.6

(51) Int. Cl. H05B 3/06; H01R 13/502; H01R 25/16; H01R 12/55

(52) U.S. Cl. CPC H05B 3/06; H01R 13/502; H01R 25/161; H01R 12/55; H05B 2203/016; H05B 2203/023

(57) ABSTRACT

A heating device includes a PCB (10), at least one heating element (30, 31, 32), bus bars (60a, 60b, 60c) and a terminal pin (40) and a terminal plate (70). At least a portion of the PCB (10) extends out of a PCB housing (20). The terminal pin (40) is disposed in a connector housing (50) disposed at least partially outside the PCB housing (20). At least one of the connector housing (50) and the portion of the PCB (10) extending out of the PCB housing (20) includes at least one support element (52) to support the connector housing (50) in a pre-determined position with respect to the PCB (10).

The present invention relates to a heating device, particularly, the present invention relates to Printed Circuit Board (PCB) controlled heating device for use in vehicles.

Generally, high current handling Printed Circuit Boards (PCB) were conventionally configured of copper, however, such Printed Circuit Boards of such configuration are expensive. Accordingly, a bus bar embedded Printed Circuit Board (PCB) is preferred, as such configuration of bus bar system enables configuring or assembling of different parts on bus bar terminals of the bus bar system. The bus bar terminals distribute electrical power to the different parts. Also, such configuration of the bus bar embedded Printed Circuit Board (PCB), particularly, results in effective heat dissipation by combining copper inlay.

The bus bar system includes a plurality of bus bars with each bus bar formed with at least one first terminal and at least on second terminal. The at least one first terminal of each bus bar is joined to the Printed Circuit Board (PCB). The at least one second terminal of each bus bar is connected to at least one of a positive terminal, a negative terminal and at least one heating element of a heating device such as, for example, a heater used in a vehicle. Particularly, the heating element may be used for cold starting of an engine of a vehicle or the heating element is configured at downstream of an evaporator of a Heating Ventilation and Air Conditioning unit used in the vehicle for achieving and maintaining comfort conditions inside a vehicle cabin. The bus bar terminals are often metallic strips of conductive material such as copper, brass, or aluminium that both ground and conduct electricity. The bus bars terminals are often soldered to the Printed Circuit Board.

In conventional heating devices, the Printed Circuit Board (PCB) along with the bus bars configured thereon is received inside a Printed Circuit Board (PCB) housing. As the heating device is generally placed in a confined space such as engine compartment or a Heating Ventilation and Air-conditioning housing, there is no scope of increasing size of the Printed Circuit Board housing to accommodate additional elements such as terminal pin. As such the terminal pin is received in a connector housing disposed outside the Printed Circuit Board housing. With such configuration, most the first bus bar terminals of the bus bar are joined to elements inside the Printed Circuit Board housing, such as for example, the Printed Circuit Board and at least one of the second bus bar terminals is connected to the terminal pin received in the connector housing disposed outside the Printed Circuit Board housing. Due to at least one of the second bus bar terminals being connected with the terminal pin received in the connector housing, the connector housing along with the terminal pin received therein being heavier, un-stabilizing forces are exerted on the first bus bar terminals. The un-stabilizing forces cause the first bus bar terminals to lose contact with the Printed Circuit Board (PCB) during soldering of the first bus bar terminals to the Printed Circuit Board (PCB), causing inconvenience in joining and detrimentally impacting the soldering between the first bus bar terminals and the Printed Circuit Board (PCB).

Accordingly, there is a need for a Printed Circuit Board (PCB) controlled electrical heating device and a method for configuring joint, particularly, soldered connection between elements thereof that obviates drawbacks associated with conventional heating devices and methods for configuring joint between the elements thereof. Further, there is a need for an electrical heating device and a method for configuring a joint between elements thereof that ensures sufficient contact between the elements being joined to form a robust joint there-between. Further, there is a need for an electrical heating device that is easy to manufacture, eliminates fixtures for maintaining elements thereof to be joined in contact with each other during soldering for configuring secure joint there between, thereby eliminating drawbacks such as for example residual stresses or damage associated with use of fixtures. Furthermore, there is a need for an electrical heating device and a method for configuring joint between elements thereof that eliminates inventory, associated inventory costs of fixtures and reduces manufacturing time, manufacturing defects and rejection rates. Also, there is a need for electrical heating device that are efficient, robust and reliable.

An object of the present invention is to provide a Printed Circuit Board (PCB) controlled electrical heating device and a method for configuring joint between elements thereof that obviates drawbacks associated with conventional heating devices and methods for configuring joint between elements thereof.

Another object of the present invention is to provide an electrical heating device that is easy to manufacture, eliminates fixtures for maintaining elements thereof being joined in contact with each other during joining process for configuring secure joint there between.

Still another object of the present invention is to provide an electrical heating device and a method for configuring joint between elements thereof that eliminates drawbacks such as residual stresses and damage to elements being held together to be joined and other drawbacks associated use of fixtures.

Yet another object of the present invention is to provide an electrical heating device and a method for configuring joint between elements thereof that eliminates inventory of fixtures, associated inventory costs of fixtures and reduces manufacturing time, manufacturing defects and rejection rates.

Still another object of the present invention is to provide an electrical heating device and a method for configuring joint between elements thereof that ensures sufficient contact between the elements to be joined to form robust joint there between.

In the present description, some elements or parameters may be indexed, such as a first element and a second element. In this case, unless stated otherwise, this indexation is only meant to differentiate and name elements which are similar but not identical. No idea of priority should be inferred from such indexation, as these terms may be switched without betraying the invention. Additionally, this indexation does not imply any order in mounting or use of the elements of the invention.

An electrical heating device is disclosed in accordance with an embodiment of the present invention. The electrical heating device includes a Printed Circuit Board, at least one heating element, a terminal pin and a plurality of bus bars. At least a portion of the Printed Circuit Board (PCB) extends out of a Printed Circuit Board (PCB) housing. The terminal pin is disposed in a connector housing disposed at least partially outside the Printed Circuit Board (PCB) housing. At least one of the connector housing and the portion of the Printed Circuit Board (PCB) extending out of the Printed Circuit Board (PCB) housing includes at least one support element to support the connector housing in a pre-determined position with respect to the Printed Circuit Board to define a pre-joining, assembled configuration.

Further, each bus bar includes at least one first terminal and at least one second terminal, the at least one first terminal is joined to the Printed Circuit Board (PCB) and the at least one second terminal adapted to be connected to at least one of the terminal pin, a terminal plate and the at least one heating element.

Specifically, the at least one first terminal of a first bus bar of the plurality of bus bars is joined to the Printed circuit Board (PCB) and at least one second terminal of the first bus bar is connected to the terminal pin and the at least one heating element.

Further, the at least one first terminal of a second bus bar of the plurality of bus bars is joined to the Printed circuit Board (PCB) and at least one second terminal of a second bus bar is connected to the at least one heating element.

Furthermore, the at least one first terminal of a third bus bar of the plurality of bus bars is joined to the Printed circuit Board (PCB) and at least one second terminal of a third bus bar is connected to the terminal plate.

Generally, the at least one support element is either one of integrally formed and secured to the connector housing and extends toward and rests on the Printed Circuit Board (PCB) in the pre-joining, assembled configuration.

Alternatively, the at least one support element is either one of integrally formed and secured to the Printed Circuit Board (PCB) and extends toward and supports at least a base portion radially extending from the connector housing in the pre-joining, assembled configuration.

In accordance with a yet another embodiment of the present invention, the at least one support element is of two parts, wherein a first part is either one of integrally formed and secured to the connector housing whereas the second part is either one of integrally formed and secured to the Printed Circuit Board (PCB), the first part and the second part collectively supports the connector housing in the pre-joining, assembled configuration.

Specifically, the at least one support element is either one of supported on and extending from at least a portion of a periphery of an opening configured on the portion of the Printed Circuit Board extending out of the Printed Circuit Board (PCB) housing and receiving the connector housing.

In accordance with an embodiment of the present invention, the terminal pin acts as a positive terminal whereas the terminal plate acts as a negative terminal.

Alternatively, the terminal pin acts as a negative terminal whereas the terminal plate acts as a positive terminal.

Specifically, the plurality of bus bars form electrical connection between the terminal pin and the terminal plate through the at least one heating element. The at least one first terminal of each bus bar is joined to the Printed circuit Board (PCB) that controls flow of electric current through the at least one heating element. At least one of the second terminals of the bus bars is connected to at least one of the terminal pin and the terminal plate.

Also, a method for configuring secure solder connection between a plurality of bus bars and a Printed Circuit Board (PCB) of a heating device is disclosed in accordance with an embodiment of the present invention. The method include steps of receiving at least a portion of a connector housing in an opening configured on a portion of the Printed Circuit Board (PCB) extending outside a Printed Circuit Board (PCB) housing. Thereafter, supporting at least one support element configured on either one of the connector housing and a periphery of the opening configured on the portion of the Printed Circuit Board extending out of the Printed Circuit Board (PCB) housing to provide support to the connector housing in a pre-determined position with respect to the PCB and to maintain a plurality of first bus bar terminals of the plurality of bus bars with at least one bus bar connected to a terminal pin received in the connector housing, in contact with a portion of the Printed Circuit Board (PCB) received inside the Printed Circuit Board (PCB) housing. Finally, configuring joint between the first bus bar terminals and the portion of the Printed Circuit Board (PCB) received inside the Printed Circuit Board (PCB) housing, as the first bus bar terminals are maintained in contact with the portion of Printed Circuit Board (PCB) received inside the Printed Circuit Board (PCB) housing.

Specifically, configuring of joint between the first bus bar terminals and the portion of the Printed Circuit Board (PCB) received inside the Printed Circuit Board (PCB) housing is achieving by soldering.

Other characteristics, details and advantages of the invention can be inferred from the description of the invention hereunder. A more complete appreciation of the invention and many of the attendant advantages thereof will be readily obtained as the same becomes better understood by reference to the following detailed description when considered in connection with the accompanying figures, wherein:

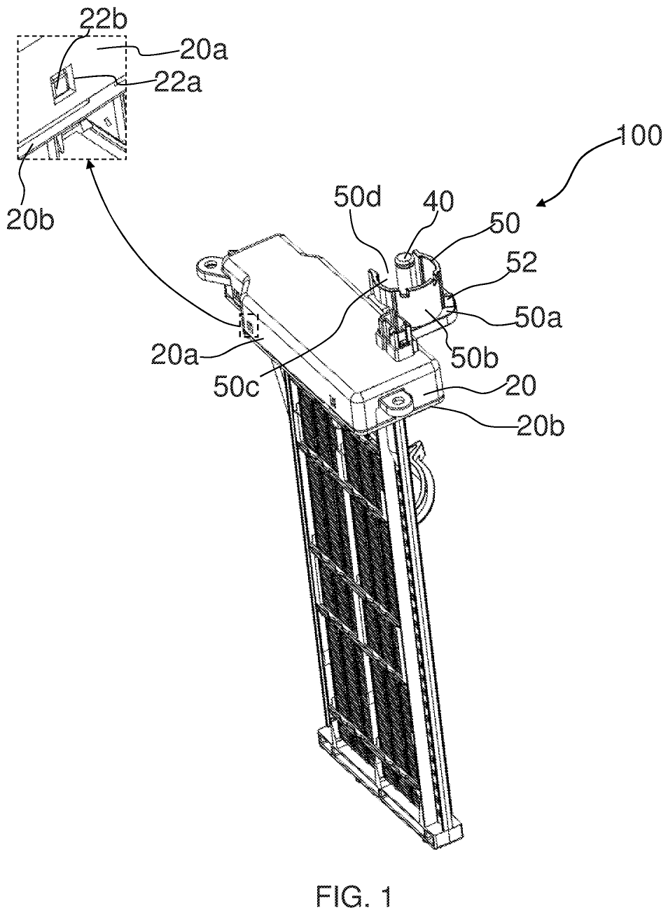

FIG. 1 illustrates an isometric view of a Printed Circuit Board (PCB) controlled heating device in accordance an embodiment of the present invention without showing a portion of the PCB that extends outside a PCB housing, also is depicted an enlarged view depicting connection between complimentary engagement elements formed on a first and a second portion of the housing;

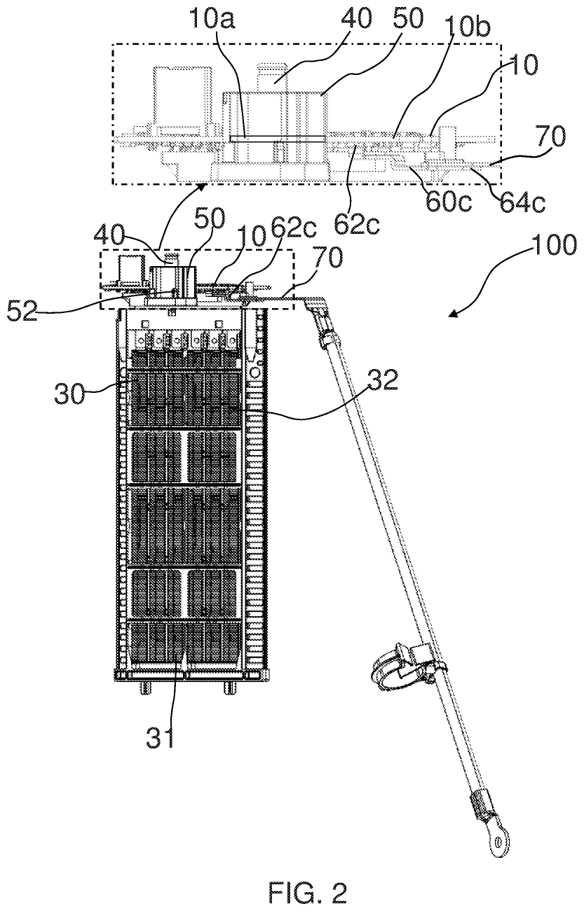

FIG. 2 illustrates another view of the Printed Circuit Board (PCB) controlled heating device of FIG. 1, along with an enlarged view depicting elements thereof such as a terminal pin disposed in a connector housing, a PCB, a terminal plate and first and second terminals of bus bars;

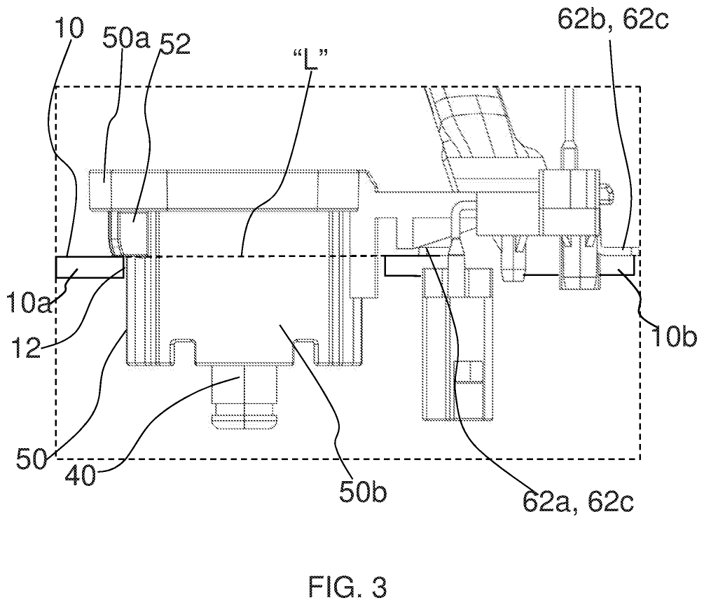

FIG. 3 illustrates another enlarged view depicting the terminal pin received in the connector housing, the PCB, and the first and second terminals of the bus bars of FIG. 2 and inter-connection there-between;

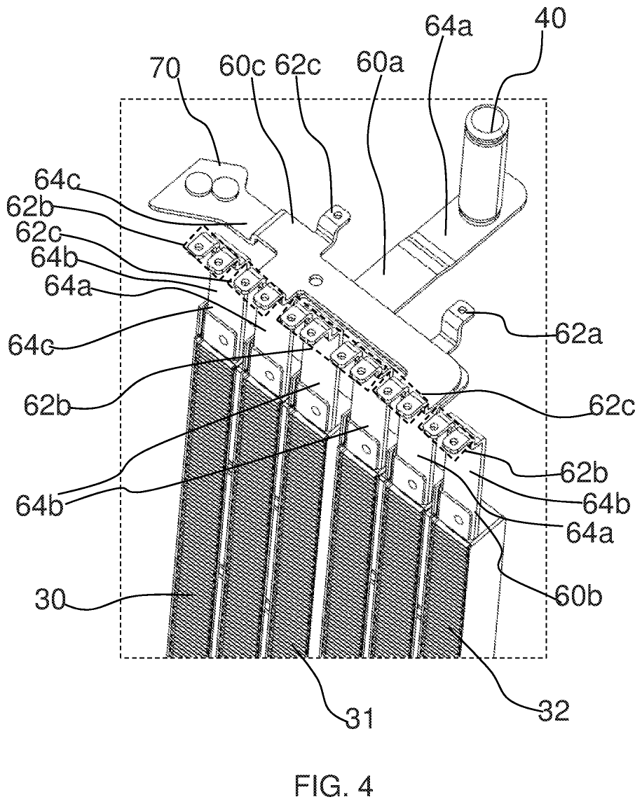

FIG. 4 illustrates another enlarged view depicting the various bus bars of the Printed Circuit Board (PCB) controlled heating device of FIG. 1 and connection between second terminals of the bus bars and at least one of the terminal pin, the terminal plate and at least one of the heating elements;

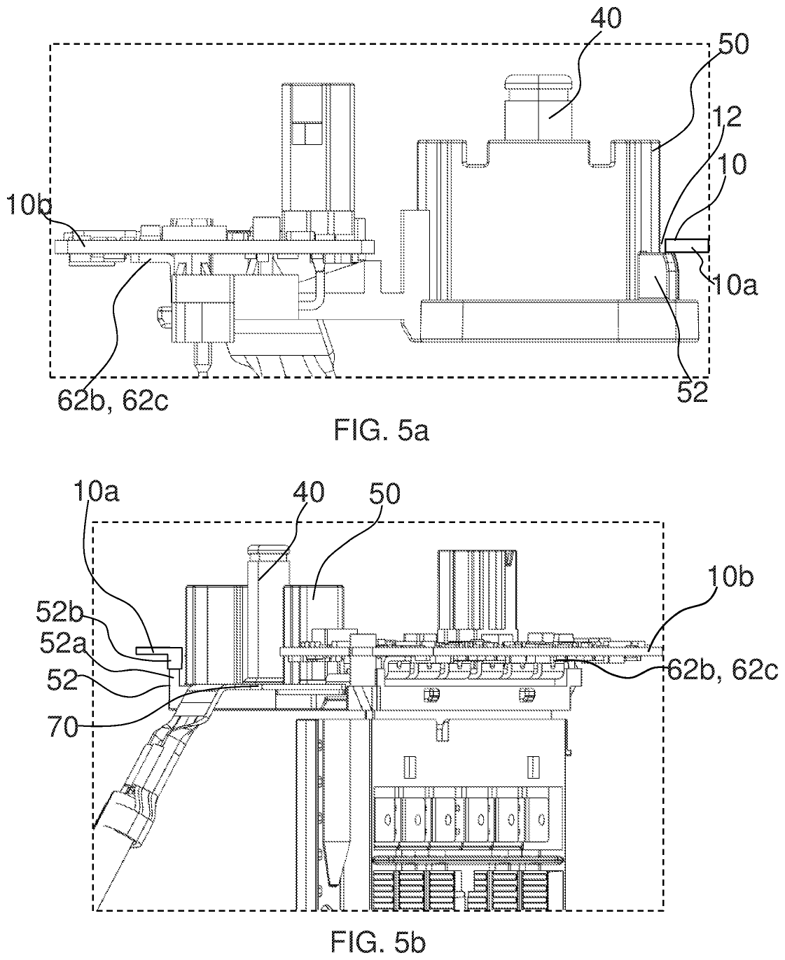

FIG. 5a illustrates enlarged views depicting at least one support element in accordance with an embodiment of the present invention to support the connector housing in a pre-determined position with respect to the Printed Circuit Board (PCB); and

FIG. 5b illustrates enlarged views depicting at least one support element of two-part configuration in accordance with another embodiment of the present invention.

It must be noted that the figures disclose the invention in a detailed enough way to be implemented, said figures helping to better define the invention if needs be. The invention should however not be limited to the embodiment disclosed in the description.

The present invention envisages a Printed Circuit Board (PCB) controlled electrical heating device, hereinafter, simply referred to as a heating device. The heating device includes a Printed Circuit Board (PCB), hereinafter simply referred to as “PCB”, at least one heating element, a terminal pin, a terminal plate and a plurality of bus bars. At least a portion of the PCB extends out of the Printed Circuit Board (PCB) housing, hereinafter, simply referred to as a “PCB housing”. The plurality of bus bars configures connection between the terminal pin and the terminal plate through the at least one heating element. Each bus bar includes at least one first terminal joined to a printed Circuit Board (PCB) disposed inside the PCB housing and at least one second terminal connected to at least one of the terminal pin, the terminal plate, and the at least one heating element. Specifically, at least one of the bus bars is connected to at least one of the terminal plate and the terminal pin received in a connector housing formed outside the PCB housing. Although, the present invention relates to the heating device that includes at least one support element to support the connector housing in a pre-determined position with respect to the Printed Circuit Board (PCB) to maintain the first bus bar terminals in contact with the Printed Circuit Board (PCB). However, the present invention is also applicable for other devices that includes a plurality of bus bars with bus bar terminals to be maintained in contact with the PCB for configuring joint there between, but at least one of the bus bars being connected to a heavy, unstable component disrupts contact between the bus bars and the PCB.

FIG. 1 and FIG. 2 illustrate isometric views of an electrical heating device, simply referred to as a heating device 100 in accordance an embodiment of the present invention. The heating device 100 includes a PCB 10 received with at least a portion 10a thereof extending out of a PCB housing 20 and a remaining portion 10b thereof disposed inside the PCB housing 20. Particularly, FIG. 1 illustrates the heating device 100, without the portion 10a of the PCB 10 that extends outside the PCB housing 20. The heating device 100 further includes at least one heating element. The heating device 100 in the forthcoming description and drawings is explained with example of heating device 100 with three heating elements, 30, 31, 32, also referred to as a first heating element 30, a second heating element 31 and a third heating element 32. The heating device 100 still further includes a terminal pin 40 received in a connector housing 50, a terminal plate 70 and a plurality of bus bars. In accordance with an embodiment, the terminal pin 40 acts as a negative terminal, whereas the terminal plate 70 acts as a positive terminal. In accordance with another embodiment of the present invention, the terminal pin 40 received inside the connector housing 50 acts as the positive terminal, whereas the terminal plate 70 acts as the negative terminal. The terminal pin 40 and the terminal plate 70 are connected by the bus bars 60a, 60b, 60c through the heating elements, 30, 31, 32. The heating device in the forthcoming description is explained with example of heating device 100 with three bus bars 60s, 60b, 60c, also referred to as a first bus bar 60a, a second bus bar 60b and a third bus bar 60c. Particularly, FIG. 2 illustrates the heating device 100 without a top cover or a first portion 20a of the PCB housing 20 to depict internal details and elements received inside the PCB housing 20. More specifically, FIG. 2 illustrates another view of the heating device 100 with an enlarged view depicting the terminal pin 40 disposed in the connector housing 50. The enlarged view also depicts at least the portion 10b of the PCB 10, at least one of first terminal 62a, 62b, 62c and at least one second terminal 64a, 64b, 64c of each of the bus bars 60a, 60b, 80c received inside the PCB housing 20.

Again referring to the FIG. 1, the PCB housing 20 includes the top cover or the first portion 20a and a second portion 20b configured with complimentary engaging elements 22a and 22b for facilitating engagement between the first portion 20a and the second portion 20b of the PCB housing 20 to configure an enclosure. The FIG. 1 also illustrates an enlarged view of the engagement between the complimentary engaging elements 22a and 22b. The complimentary engaging elements 22a and 22b are apertures and complimentary snap fit engagement elements respectively. However, the present invention is not limited to any particular configuration of the PCB housing 20 as far as the PCB housing 20 is having a modular configuration and defines enclosure for receiving at least the portion 10b of the PCB 10 along with the bus bars 60a, 60b, 60c and other elements. Further, the present invention is not limited to any particular configuration of the complimentary engaging elements 22a and 22b as far as the complimentary engagement elements are capable of configuring releasable engagement between the first portion 20a and the second portion 20b of the PCB housing 20 to impart modular configuration to the PCB housing 20. Such modular configuration of the PCB housing 20 provides access to the elements received inside the PCB housing 20 for maintenance and replacement, thereby easing the maintenance activities.

The at least one heating elements 30, 31, 32 are electrical heating elements that generate heat upon passage of electric current there through. However, the present invention is not related to any particular configuration, number and arrangement of the at least one heating elements 30, 31, 32, as far as the at least one heating elements are capable of being connected to at least one of second bus bar 2s terminals 64b, 64c and generating heat upon passage of electric current there through.

The terminal pin 40 is disposed in the connector housing 50. The connector housing 50 is disposed at least partially outside the PCB housing 20. Generally, the terminal pin 40 is connected to at least one second terminal 64a of the bus bar 60a of the plurality of bus bars 60s, 60b, 60c extending out of the PCB housing 20. In one embodiment, the terminal pin 40 is integrally formed on the at least one second terminal 64a extending out of the PCB housing 20. Alternatively, the terminal pin 40 is detachably mounted on the at least one second terminal 64a extending out of the PCB housing 20. Specifically, the terminal pin 40 is either removably received in an aperture formed on the at least one second terminal 64a or the terminal pin 40 is secured to the aperture formed on the at least one second terminal 64a extending out of the PCB housing 20.

The terminal pin 40 is received inside the connector housing 50 disposed outside the PCB housing 20. FIG. 3 illustrates another enlarged view depicting the terminal pin 40 disposed in the connector housing 50, also is depicted, the PCB 10, and the first and second terminals 62a, 62b of the bus bars 60a, 60b and inter-connection there-between. Again referring to the FIG. 1, the connector housing 50 extends out of the PCB housing 20 from a side of the PCB housing 20. More specifically, the connector housing 50 includes a base portion 50a and a tubular 1s portion 50b formed on the base portion 50. The tubular portion 50b is configured with an open extreme end 50c and an open side 50d. The open extreme end 50c along with the open side 50d of the connector housing 50 facilitates receiving of a power connector, simply referred to as connector inside the connector housing 50. Specifically, the tubular portion 50b of the connector housing 50 is complimentary to an external profile of the connector and receives the connector. The connector engages with the terminal pin 40 received inside the connector housing 50 and supplies electrical current to the terminal pin 40.

With such configuration, the connector engaging with the terminal pin 40 is disposed outside the PCB housing 20 instead of being disposed in a confined space inside the PCB housing 20 or above the PCB housing 20. Particularly, such configuration provides sufficient space for configuring secure connection between the terminal pin 40 and the connector of any configuration without even requiring any modification of the PCB housing 20, particularly, in cases where there is limited space above the PCB housing 20. Further, such configuration ensures secure connection between the terminal pin 40 and the connector without damaging electronic elements disposed inside the PCB housing 20. Furthermore, such configuration of the connector housing 50 provides flexibility to position or select different shapes, sizes and configurations of the engaging terminal pin 40 and the connector.

The plurality of bus bars, particularly three bus bars 60s, 60b, 60c forms electrical connection between the terminal pin 40 and the terminal plate 70 through the heating elements 30, 31, 32. The at least one first terminal 62a, 62b, 62c of each of the bus bars 60s, 60b, 60c is connected to the PCB 10. Further, the at least one second terminal 64a, 64b, 64c of each of the bus bars 60s, 60b, 80c is connected to at least one of the terminal pin 40, the terminal plate 70 and the at least one heating element 30, 31, 32. Specifically, referring to the FIG. 4, the at least one first terminal 62a of the first bus bar 60a is joined to the PCB 10 and at least one second terminal 64a of the first bus bar 60a is connected to the terminal pin 40 and the at least one of the first and the third heating element 30, 32. More specifically, the first bus bar 60a includes one first terminal 62a joined to the PCB 10 and two second terminals 64a, wherein one of the second terminals 64a is connected to the first heating element 30 whereas another second terminal 64a is connected to the third heating element 32. Further, the at least one first terminal 62b of the second bus bar 60b is joined to the PCB 10 and the at least one second terminal 64b of the second bus bar 60b is connected to the at least one of the first, the second and the third heating element 30, 31, 32. More specifically, the second bus bar 60b includes four first terminal 62b joined to the PCB 10 and four second terminals 64b, wherein two second terminals are connected to the second heating element 31 and remaining two second terminals are connected to the first and the second heating elements 30 and 32. Still further, the at least one first terminal 62c of the third bus bar 60c is joined to the PCB 10 and the at least one second terminal 64c of the third bus bar 80c is connected to the terminal plate 70. More specifically, the bus bar 80c includes three first terminals 62c joined to the PCB 10 and one second terminal 64c connected to the terminal plate 70. With such configuration of the at least one first terminal 62a, 62b, 62c and the at least one second terminal 64a, 64b. 64c of each of the bus bars 60, 60b, 60c, the PCB 10 controls flow of electric current through the at least one heating element 31, 32, 33.

The at least one of the connector housing 50 and the portion 10a of the PCB extending out of the PCB housing 20 includes at least one support element 52. The at least one support element 52 supports the connector housing 50 in a pre-determined position with respect to the PCB 10 to define a pre-joining, assembled configuration. In the pre-joining assembled configuration, the connector housing 50 in inverted configuration thereof and the tubular portion 50b thereof received in an opening 12 formed on the portion 10a of the PCB 10 extending out of the PCB housing (as illustrated in FIG. 3), the at least one support element 52 rests on the PCB 10 and stably supports the connector housing 50. Specifically, in the pre-joining assembled configuration, tip of the at least one support element 52 and the tip of the at least one second terminal 64a, 64b, 64c rests on the PCB 10 and are maintained at same level “L”. More specifically, in the pre-joining, assembled configuration, the first terminals 62e, 62b, 62c including the first terminal 62a connected to the terminal pin 40 received in the connector housing 50 are maintained in contact with the portion 10b of the PCB 10 disposed inside the PCB housing 20. In accordance with an embodiment of the present invention, the at least one support element 52 integrally formed with the connector housing 50 extends toward and rests on the PCB 10 in the pre-joining, assembled configuration as illustrated in FIG. 5a. Specifically, the connector housing 50 along with the at least one support element 52 is formed as one-piece component by moulding. Alternatively, the at least one support element 52 secured to the connector housing 50 extends toward and rests on the PCB 10 in the pre-joining, assembled configuration. In accordance with still another embodiment of the present invention, the at least one support element 52 integrally formed with the PCB 10 extends toward and supports the base portion S that is radially extending from the connector housing 50, in the pre-joining, assembled configuration.

Alternatively, the at least one support element 52 secured to the PCB 10 extends toward and supports the base portion 50s that is radially extending from the connector housing 50 in the pre-joining, assembled configuration. In accordance with still another embodiment of the present invention, the at least one support element 52 is of two parts, particularly, a first part 52a and a second part 52b. The first part 52a is either integrally formed with or secured to the connector housing 50, whereas the second part 52b is either integrally formed with or secured to the PCB 10. In one embodiment, the first part 52a and the second part 52b of the at least one support element 52 extend towards each other and support each other to provide support to the connector housing 50 in the pre-joining, assembled configuration as illustrated in FIG. 5b. In accordance with still another embodiment, the first part 52a extend from the connector housing 50 and supports in the PCB 10 and the second part 52b extends from the PCB 10 and rests on the base portion 50a that is radially extending from the connector housing 50. The first part 52a and the second part 52b collectively supports the connector housing 50 in the pre-joining, assembled configuration. The at least one support element 52 is either supported on or extending from at least a portion of a periphery of the opening 12 configured on the portion 10a of the PCB 10 extending out of the PCB housing 20 and receiving the tubular portion 50b of the connector housing 50. However, the present invention is not limited to any particular configuration, number, placement or arrangement of the at least one support element 52 and the connection thereof with the connector housing 50, as far as the at least one support element 52 is capable of providing support to the connector housing 50 in the pre-determined position with respect to the PCB 10 in the pre-joining, assembled configuration.

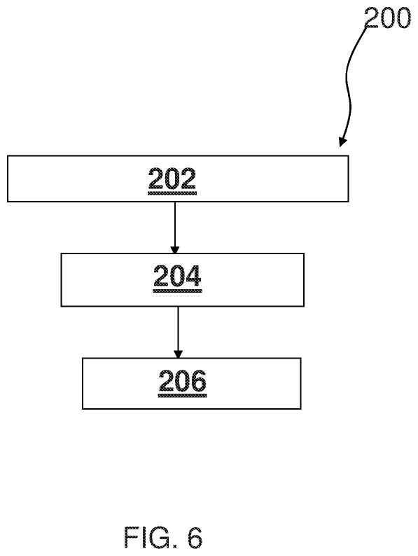

Also, a method 200 for configuring secure joint between a plurality of bus bars 60s, 60b, 60c and a PCB 10 of a heating device 100 is disclosed in accordance with an embodiment of the present invention. FIG. 6 is a flowchart depicting the method 200 for configuring secure joint between the bus bars 60, 60b, 60c, particularly, between the first terminals 62a, 62b, 62c of each of the bus bars 60s, 60b, 60c and the PCB 10, wherein steps of the method are depicted by blocks in the flow diagram. The order in which the individual blocks depicting the steps involved in the method appear in the flow chart is not intended to be construed as a limitation. Any number of steps depicted as blocks in the flow chart can be combined in any order or can be performed in parallel to employ the method 200, or an alternative method. Additionally, individual blocks may be deleted from the flow chart depicting the method without departing from the scope and ambit of the present invention. The method 200 may include steps mentioned in the below description for configuring secure joint between the first terminals 62a, 62b, 62c of each of the bus bars 60a, 60b, 60c and the PCB 10. The method 200 is to be understood with reference to the following description along with the FIG. 6.

The method 200 include a step 202 of receiving at least a portion of a connector housing 50 in an opening 12 configured on a portion 10a of the PCB 10 extending outside a PCB housing 20. Thereafter, the method includes a step 204 of supporting at least one support element 52 configured on either one of the connector housing 50 and a periphery of the opening 12 configured on the portion 10a of the PCB 10 extending out of the PCB housing 20 to support the connector housing 50 in a pre-determined position with respect to the PCB 10 and maintain a plurality of first terminals 62a, 62b, 62c of a plurality of bus bars 60s, 60b, 60c along with at least one bus bar connected to a terminal pin 40 received in the connector housing 50 in contact with a portion 10b of the PCB 10 received inside the PCB housing 20 to define a pre-joining, assembled configuration. Finally, the method includes a step 206 of configuring joint between the first terminals 62a, 62b, 62c and the portion 10b of the PCB 10 received inside the PCB housing 20, as the first terminals 623, 62b, 62c are maintained in contact with the portion 10b of the PCB 10 received inside the PCB housing 20. The step 206 of configuring joint between the first terminals 62a, 62b, 62c and the portion 10b of the PCB 10 received inside the PCB housing 20 is achieving by soldering. However, the present invention is not limited to any particular joining process for configuring joint between the first terminals 62a, 62b, 62c and the portion 10b of the PCB 10 received inside the PCB housing 20 and any other joining process that requires sufficient contact between the first terminals 62a, 62b, 62c and the portion 10b of the PCB 10 received inside the PCB housing 20 can be used.

Several modifications and improvement might be applied by the person skilled in the art to the electrical heating device 100 as defined above, and such modifications and improvements will still be considered within the scope and ambit of the present invention, as long as the system comprises a Printed Circuit Board (PCB), at least one heating element, a terminal pin and a plurality of bus bars. At least a portion of the Printed Circuit Board (PCB) extends out of a Printed Circuit Board (PCB) housing. The terminal pin is received in a connector housing disposed at least partially outside the Printed Circuit Board (PCB) housing. The plurality of bus bars form electrical connection between the terminal pin and a terminal plate through the at least one heating element. Each bus bar includes at least one first terminal joined to the Printed circuit Board (PCB) that controls flow of electric current through the at least one heating element. At least one of the bus bars is connected to the terminal pin. At least one of the connector housing and the portion of the Printed Circuit Board (PCB) extending out of the Printed Circuit Board (PCB) housing includes at least one support element to support the connector housing in a pre-determined position with respect to the Printed Circuit Board to define a pre-joining, assembled configuration.

Obviously, numerous modifications and variations of the present invention are possible in light of the above teachings. It is therefore to be understood that the invention may be practiced otherwise than as specifically described herein.

In any case, the invention cannot and should not be limited to the embodiments specifically described in this document, as other embodiments might exist. The invention shall spread to any equivalent means and any technically operating combination of means.

1. An electrical heating device comprising:
a Printed Circuit Board (PCB) with at least portion thereof extending out of a Printed Circuit Board (PCB) housing;
at least one heating element;
a terminal pin received in a connector housing disposed at least partially outside the Printed Circuit Board housing; and
a plurality of bus bars,
wherein at least one of the connector housing and the portion of the Printed Circuit Board extending out of the Printed Circuit Board housing comprises at least one support element adapted to support the connector housing in a pre-determined position with respect to the Printed Circuit Board to define a pre-joining, assembled configuration.

2. The electrical heating device as claimed in claim 1, wherein each bus bar comprises at least one first terminal and at least one second terminal, the at least one first terminal is joined to the Printed Circuit Board (PCB) and the at least one second terminal is adapted to be connected to at least one of the terminal pin, a terminal plate and the at least one heating element.

3. The electrical heating device as claimed claim 2, wherein at least one first terminal of a first bus bar of the plurality of bus bars joined to the Printed Circuit Board and the at least one second terminal of the first bus bar is connected to the terminal pin and the at least one heating element.

4. The electrical heating device as claimed in the claim 2, wherein at least one first terminal of a second bus bar of the plurality of bus bars joined to the Printed Circuit Board and the at least one second terminal of the second bus bar is connected to the at least one heating element.

5. The electrical heating device as claimed in the claim 2, wherein at least one first terminal of a third bus bar of the plurality of bus bars is joined to the Printed Circuit Board and the at least one second terminal of the third bus bar is connected to the terminal plate.

6. The electrical heating device as claimed in claim 1, wherein the at least one support element is either one of integrally formed with and secured to the connector housing and is adapted to extend toward and rest on the Printed Circuit Board in the pre-joining, assembled configuration.

7. The electrical heating device as claimed in claim 1 any, wherein the at least one support element is either one of integrally formed with and secured to the Printed Circuit Board and is adapted to extend toward and support at least a base portion radially extending from the connector housing in the pre-joining, assembled configuration.

8. The electrical heating device as claimed in claim 1, wherein the at least one support element is of two parts, wherein a first part is either one of integrally formed and secured to the connector housing whereas a second part is either one of integrally formed and secured to the Printed Circuit Board, the first part and the second part are collectively adapted to support the connector housing in the pre-joining, assembled configuration.

9. The electrical heating device as claimed in claim 1, wherein the at least one support element is either one of supported on and extending from at least a portion of a periphery of an opening configured on the portion of the Printed Circuit Board extending out of the Printed Circuit Board (PCB) housing and receiving the connector housing.

10. The electrical heating device as claimed in claim 2, wherein the terminal pin acts as a positive terminal, whereas the terminal plate acts as a negative terminal.

11. The electrical heating device as claimed in claim 2, wherein the terminal pin acts as a negative terminal, whereas the terminal plate acts as a positive terminal.

12. The electrical heating device as claimed in claim 2, wherein the plurality of bus bars form electrical connection between the terminal pin and the terminal plate through the at least one heating element, the at least one first terminal of each bus bar is joined to the Printed circuit Board that is adapted to control flow of electric current through the at least one heating element, at least one of the second terminals of the bus bars is connected to at least one of the terminal pin and the terminal plate.

13. A method for configuring secure joint between a plurality of bus bars and a Printed Circuit Board of an electrical heating device, the method comprising:
receiving at least a portion of a connector housing in an opening configured on a portion of the Printed Circuit Board extending outside a Printed Circuit Board housing;
supporting the connector housing in a pre-determined position with respect to the Printed Circuit Board to maintain a plurality of first terminals with at least one first terminal connected to a terminal pin received in the connector housing in contact with a portion of the Printed Circuit Board received inside the Printed Circuit Board (PCB) housing; and
configuring joint between the first terminals and the portion of the Printed Circuit Board received inside the Printed Circuit Board (PCB) housing, as the first terminals are maintained in contact with the portion of Printed Circuit Board received inside the Printed Circuit Board (PCB) housing.

14. The method for configuring secure joint as claimed in claim 13, wherein configuring joint between the first terminals and the portion of the Printed Circuit Board received inside the Printed Circuit Board housing is achieving by soldering.
